(19) United States
(12) Patent Application Publication
(10) Pub. No.: US 2019/0159400 A1
(43) Pub. Date: May 30, 2019

(54) Recuperation Panel of Phytosanitary Product and Spraying Machine

(71) Applicant: EXEL INDUSTRIES, Epemay (FR)

(72) Inventors: Anthony DARRIEUTORT, Paris (FR); Raphael MONCHANIN, Paris (FR)

(21) Appl. No.: 16/194,382

(22) Filed: Nov. 18, 2018

(30) Foreign Application Priority Data
Nov. 27, 2017 (FR) 1761235

(51) Int. Cl. A01C 23/04; B05B 14/00

(52) U.S. Cl. CPC A01C 23/047; B05B 14/00

(57) ABSTRACT

This phytosanitary product recuperation panel (2) comprises a recuperation surface (4) extending along a main plane (P), a recuperation tray (6) located on one edge of the recuperation surface (4) so as to receive the phytosanitary product by flow over the recuperation surface (4), and the recuperation surface (4) is formed by a plurality of fins (40) spaced apart such that a flow of air can traverse the recuperation surface (4) by passing between the fins (40).

### CROSS-REFERENCE TO RELATED APPLICATIONS

This application claims priority of French Patent Application No. 17 61235, filed on Nov. 27, 2017.

### FIELD OF THE INVENTION

The invention relates to a recuperation panel for phytosanitary product, as well as a machine for spraying phytosanitary product on a viticultural or arboreal crop.

### BACKGROUND OF THE INVENTION

In viticultural crops, it is known to spray phytosanitary products on the vines using “downspouts”, i.e., vertical elements that bear at least one spraying device. Some technologies in particular use air diffusers and spray nozzles for phytosanitary products in the form of drops with modifiable sizes carried by the airflow onto the crops.

The drawback of these systems is that a certain part of the product does not reach or does not stay on the vine, and may disperse toward the waterways, other crops or homes with the environmental problems that this entails.

To solve this problem, recuperation panels, which make it possible to recuperate part of the product that does not stay on the vine, have been created. However, the rebound phenomenon of the air sprayed on the bottom of the panel causes lateral dispersions of air charged with phytosanitary product that harm the recuperation rate of these recuperation panels.

Recuperation panels are known from FR 2,969,902, U.S. Pat. No. 6,302,332 and DE 89 06 405.

### SUMMARY OF THE DESCRIPTION

The invention aims to resolve these drawbacks by proposing a new recuperation panel allowing an increased recuperation rate of phytosanitary product relative to the materials of the prior art.

To that end, the invention relates to a phytosanitary product recuperation panel, comprising a recuperation surface extending along a main plane, and a recuperation tray located on one edge of the recuperation surface so as to receive the phytosanitary product by flow over the recuperation surface. The panel is characterized in that the recuperation surface is formed by a plurality of fins spaced apart such that a flow of air can traverse the recuperation surface by passing between the fins.

Owing to the invention, the flow of air does not cause a rebound effect on the panel and is guided, which prevents a dispersion of the phytosanitary product around the panel and improves the recuperation.

According to advantageous but optional aspects of the invention, such a recuperation panel may incorporate one or more of the following features, considered in any technically allowable combination:
The fins are tilted relative to the main plane so as to form a continuous obstacle along a direction perpendicular to the main plane.
The panel comprises an element that is permeable to the passage of air, the area of which is substantially equal to that of the recuperation surface, extending along the main plane and located behind the recuperation surface such that a flow of air traversing the panel passes first through the fins then through the element permeable to the passage of air.
The element permeable to the passage of air has meshes, the size of which is comprised between 0.5 and 2.5 mm², preferably equal to 1 mm².
The air-permeable element is a net.
The air-permeable element is placed at a distance from the fins between 0 and 150 mm.
The fins have a variable orientation relative to the main plane.
The panel has a substantially vertical longitudinal direction, and a transverse direction substantially parallel to the ground and aligned with a direction of advance of a machine transporting the panel.
The fins extend along the longitudinal direction of the panel.
The panel comprises a filtering element that is permeable to the passage of air, extending in front of the recuperation surface, said filtering element having meshes with a size greater than the size of the meshes of the element located behind the recuperation surface.
The panel comprises two recuperation surfaces located on two opposite faces of the panel on either side of the main plane.

The invention also relates to a machine for spraying phytosanitary product in a viticultural crop, comprising at least one spraying device comprising at least one nozzle for spraying phytosanitary product capable of spraying the phytosanitary product on a first side of a vine, and at least one recuperation panel located on an opposite side of said vine across from the spray nozzle.

According to advantageous but optional aspects of the invention, such a spraying machine may incorporate one or more of the following features, considered in any technically allowable combination:
The spraying device is provided on a first recuperation panel and capable of spraying phytosanitary product toward a second recuperation panel located across from the vine, the machine also comprising a second spraying device provided on the second recuperation panel and capable of spraying phytosanitary product toward the first recuperation panel.
The spraying device provided on the first recuperation panel is located in front of said panel, relative to the direction of advance of the machine, and the spraying device provided on the second recuperation panel is located behind said panel, relative to the direction of advance of the machine.
The fins of the recuperation panels have a variable orientation relative to the main plane, and the machine is capable of controlling said orientation in a slaved manner as a function of at least an orientation of the spray nozzles and/or a speed of advance of the machine.

### BRIEF DESCRIPTION OF THE DRAWINGS

The invention will be better understood and other advantages thereof will appear more clearly in light of the following description of a recuperation panel and a spraying machine according to its principle, provided as a non-limiting example and in reference to the appended drawings, in which:

FIG. 1 is a perspective view of a recuperation panel according to the invention;

FIG. 2 is an exploded perspective view of the recuperation panel of FIG. 1;

FIG. 3 is a perspective view along an opposite direction of the recuperation panel of FIG. 1;

FIG. 4 is a front view along arrow IV of the recuperation panel of FIG. 1;

FIG. 5 is a sectioned perspective view along plane V-V of the recuperation panel of FIG. 1;

FIG. 6 is a sectional view along plane V-V;

FIG. 7 is a schematic top view of a spraying machine according to the invention;

FIGS. 8 to 10 are top views similar to FIG. 7, showing alternatives of the spraying machine of FIG. 7; and

FIG. 11 is a schematic top view of a recuperation panel according to a second embodiment.

### DETAILED DESCRIPTION

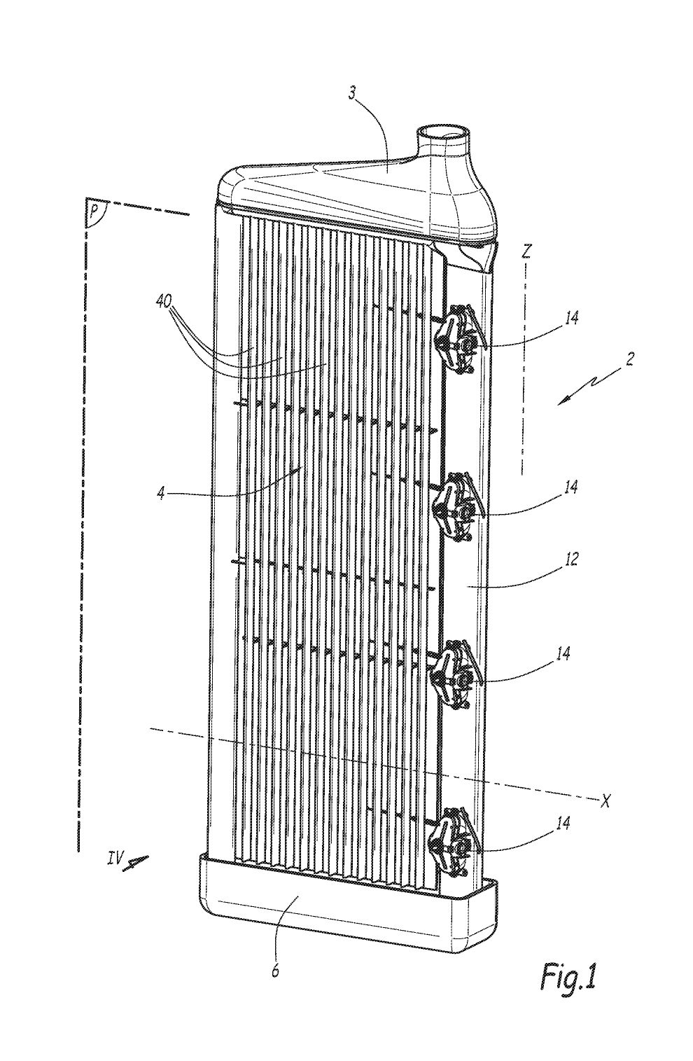

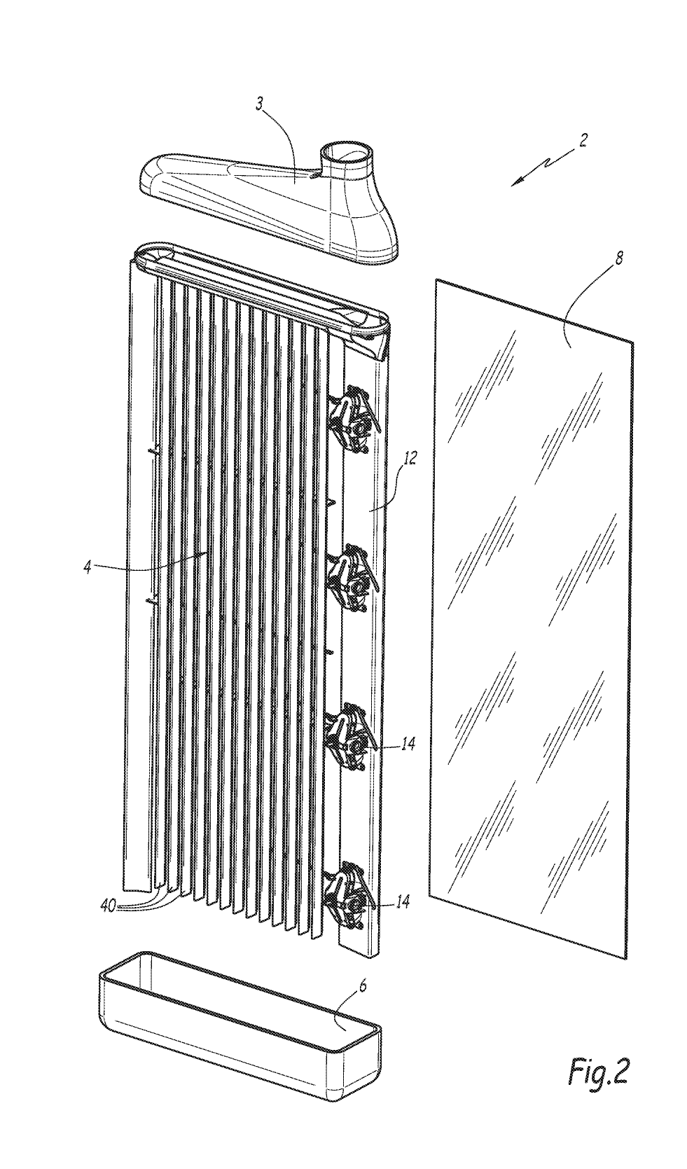

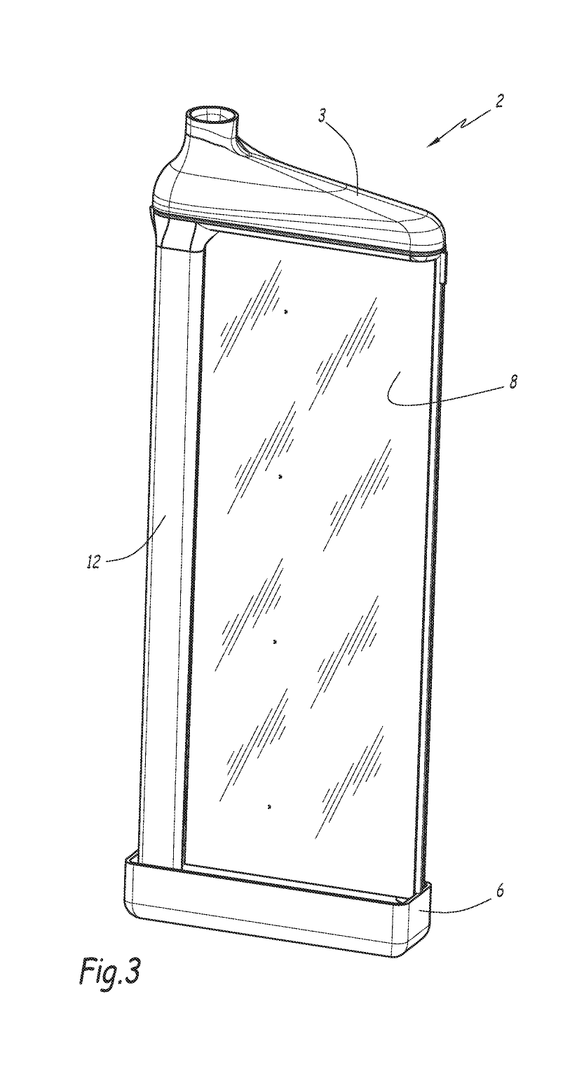

FIG. 1 shows a phytosanitary product recuperation panel 2, comprising a recuperation surface 4 extending along a main plane P, and a recuperation tray 6 located on one edge of the recuperation surface 4 so as to receive the phytosanitary product by flow over the recuperation surface 4. The main plane P is shown vertical. It may change orientation based on the movement of a spraying machine 10 on which the recuperation panel 2 is installed.

The machine 10 for spraying phytosanitary product in a viticultural crop comprises at least one spraying device 12, also called downspout, comprising at least one nozzle 14 for spraying phytosanitary product capable of spraying the phytosanitary product on a first side of a vine V, and at least one recuperation panel 2 located on an opposite side of said vine V across from the spray nozzle 14. The machine 10 moves between rows of vines V along a direction of advance X.

The machine 10 can also be adapted to treat arboreal crops.

The nozzles 14 are combined with air diffusers that blow a stream of air F, which carries the phytosanitary product dispersed in the form of droplets toward the vines. An air intake pipe 3 is provided on an upper part of the panel 2.

The devices 12 are combined with the recuperation panels 2. In practice, a first spraying device 12A is provided on a first recuperation panel 2A and capable of spraying phytosanitary product toward a second recuperation panel 2B located across from the vine V. A second spraying device 12B [is] provided on the second recuperation panel 2B and capable of spraying phytosanitary product toward the first recuperation panel 2A.

The spraying device 12A is located on the front side 16 of the panel 2A, relative to the direction of advance X of the machine 10, and the spraying device 12B is located on the rear side 18 of the panel 2B, relative to the direction of advance X.

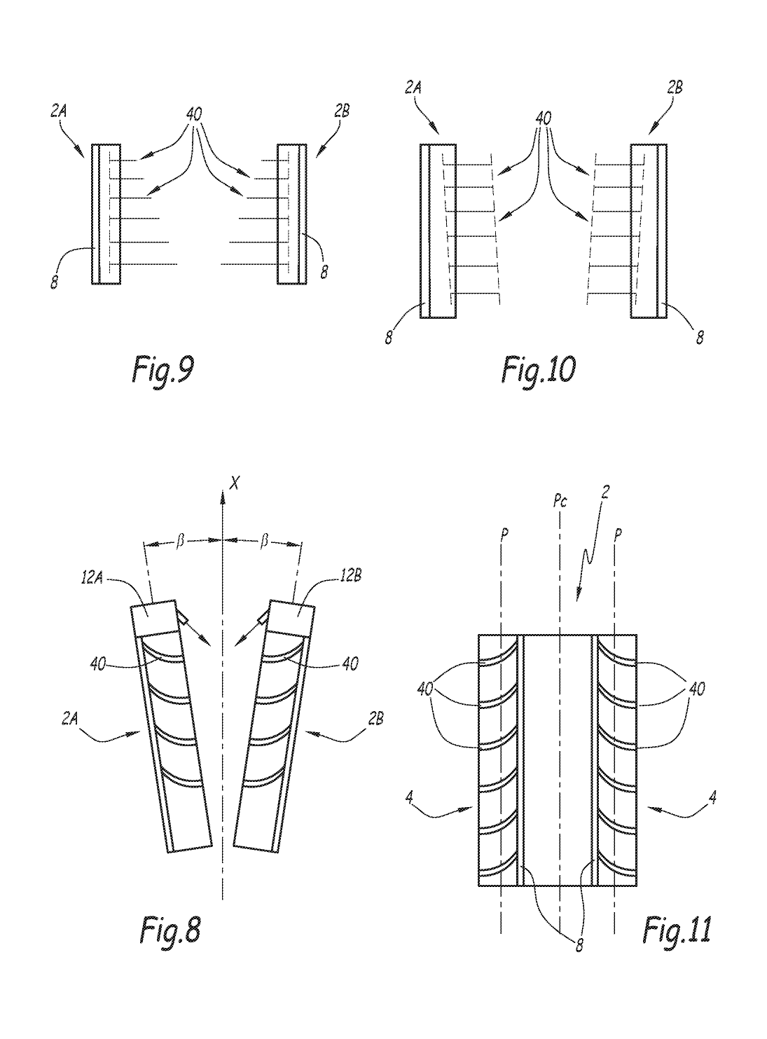

Alternatively, the spraying devices 12A and 12B are all arranged on the front side, or on the rear side. Thus, as shown in FIG. 8, the spraying devices 12A and 12B are arranged toward the front of the panels 2A and 2B.

The blowing directions of the nozzles 14 can be modified and are oriented relative to the main plane P. To account for the effect of the advance of the machine 10 on the path of the air flow F, the blowing direction of the spraying device 12A, located in the front, is different from the blowing direction of the spraying device 12B, located in the rear. The direction of the air flow F of the spraying device 12A forms an angle α1 relative to a direction perpendicular to the direction of advance X. The angle α1 is between −15° and 15°, preferably between 0 and 10°, still more preferably equal to 5°. The direction of the air flow F of the spraying device 12B forms an angle α2 relative to a direction perpendicular to the direction of advance X. The angle α2 is between 0° and 45°, preferably between 0 and 25°, still more preferably equal to 15°. The given positive values of the examples of angles correspond to directions of air flows F oriented toward the rear relative to the direction of advance X of the machine 10.

In a known manner, the panels 2 and the associated spraying devices 12 are supported by a support structure, not shown, and the machine 10 can be self-propelled, mounted on a vehicle, or pulled.

The recuperation surface 4 is formed by a plurality of fins 40 spaced apart such that the flow of air F can traverse the recuperation surface 4 by passing between the fins 40. Thus, instead of bouncing on a solid panel, the air bearing the droplets of phytosanitary product passes through an open-worked surface, in which the air is guided, and the air flow is broken to reduce its energy and its dispersion.

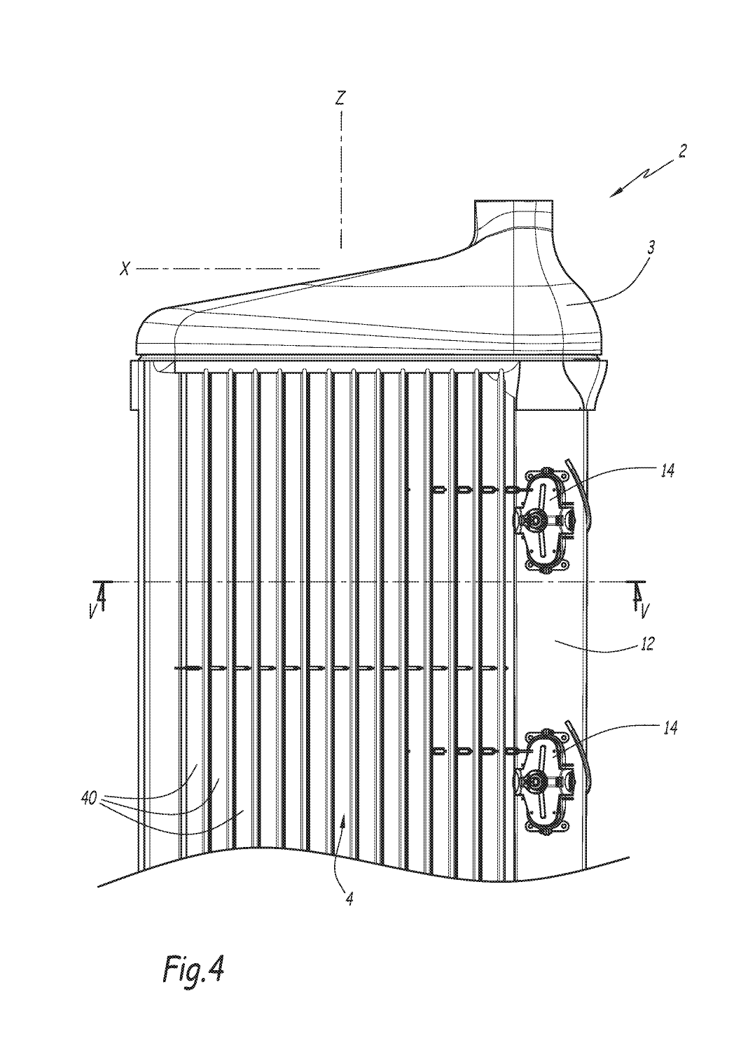

The fins 40 are tilted relative to the main plane P with an angle θ so as to form a continuous obstacle along a direction perpendicular to the main plane P. As shown in FIG. 4, there is no space between the fins 40, such that the maximum amount of phytosanitary product is recovered, while allowing air to pass. In general, the sprayed surface of the fins 40 along a direction parallel to the direction of the air flow F is continuous.

The fins 40 can be adjustable relative to the plane P. For example, the fins 40 can be rotatable around a longitudinal axis Z40 parallel to the direction Z and to the plane P, such that the angle θ can be modified. The orientation of the fins 40 is done manually or automatically, individually or in series.

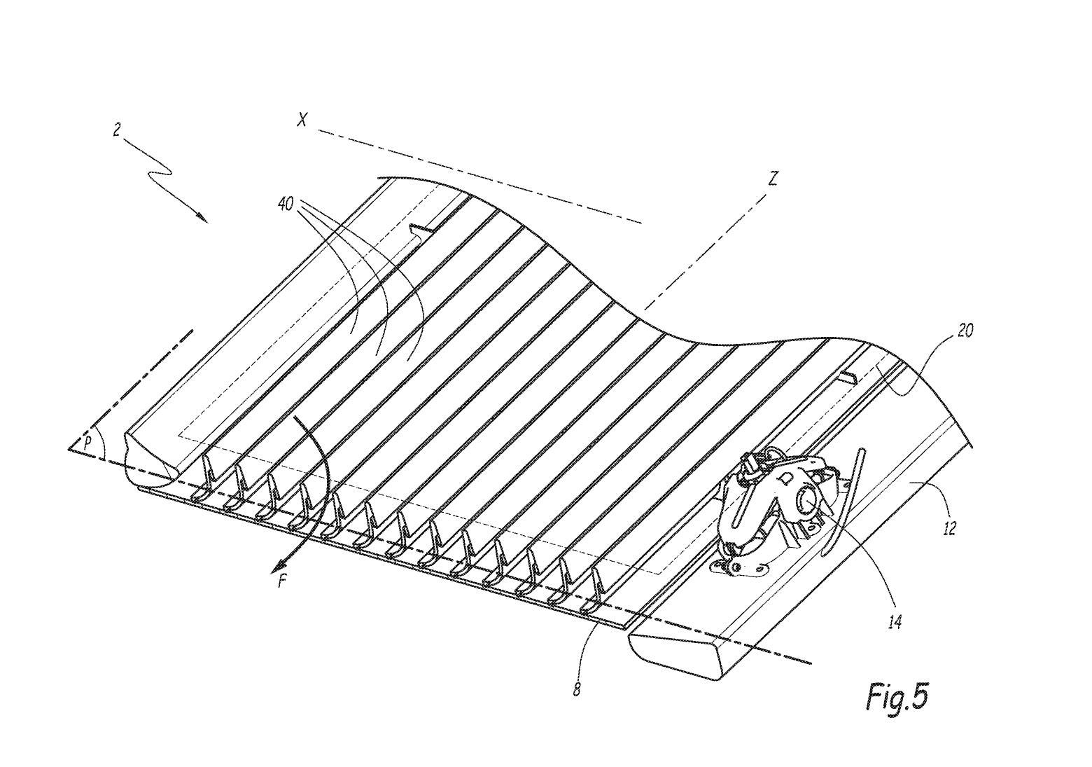

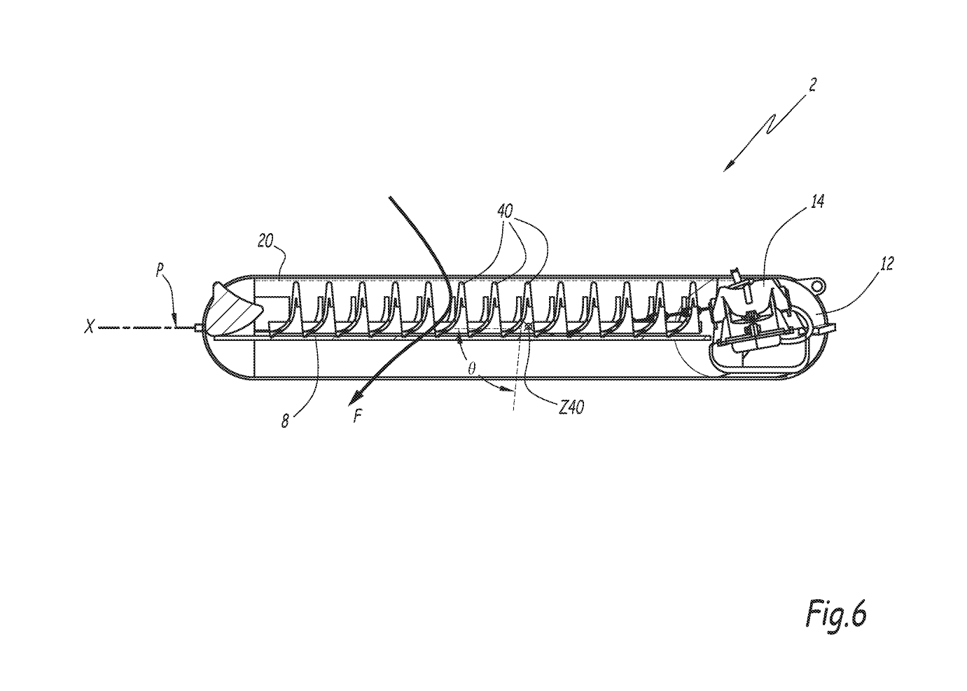

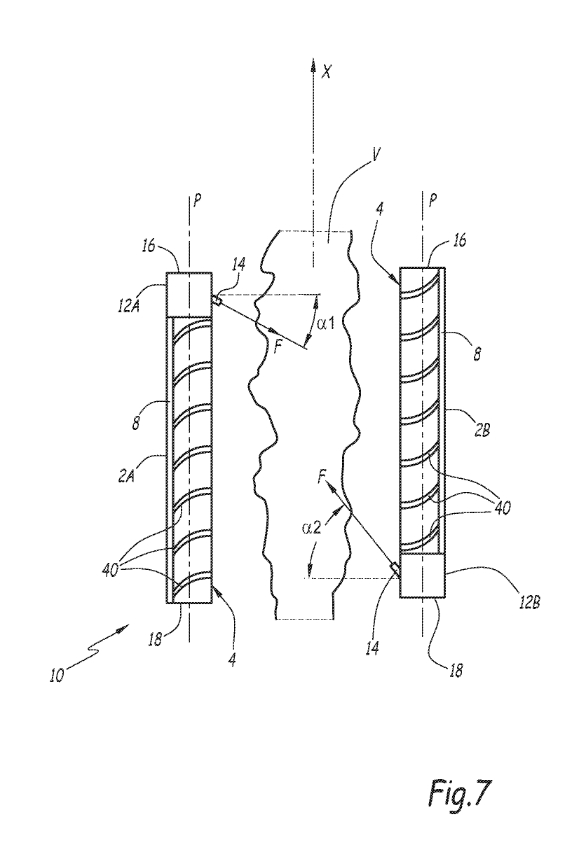

The fins 40 may have a non-rectilinear profile, as shown in FIGS. 5 and 6. In the illustrated example, the fins 40 have a curved shape. Alternatively, the fins 40 may have angles. The non-rectilinear shape makes it possible to guide the air flow along a desired direction. The fins may be solid or open-worked.

The orientation of the fins 40 may be different over the width of the panels 2. For example, the fins 40 located on the front side of the machine may have a different angle relative to the direction of advance X with respect to the fins located on the rear side of the machine.

The panels 2 may be tilted with respect to the vines V. In particular, the panels may have an open angle in the direction of advance of the machine. The panels then have a funnel or “V” shape, as shown in FIG. 8. In this case, the panels 2A and 2B may form an angle β relative to the direction of advance X.

The panel 2 comprises an element 8 that is permeable to the passage of air, or net, the area of which is substantially equal to that of the recuperation surface 4, and extending along the main plane P. The net 8 is located behind the recuperation surface 4 such that the flow of air traversing the panel 2 passes first through the fins 40 then through the net 8. Hereinafter, the net 8 is called “rear net”.

The rear net 8 may have meshes with a width between 0.5 and 2.5 mm², preferably 1 mm².

According to another unit of measure, the net may be characterized in Mesh and comprise values between 7 and 35.

A net refers to an element that is permeable to air and open-worked. The net may in particular be in the form of a mesh made from stainless steel, plastic, plastic injected in one piece.

In the illustrated example, the rear net 8 is placed against the fins 40; in an alternative that is not shown, the rear net 8 may be separated from the fins 40 by a distance of up to 150 mm, preferably between 10 and 20 mm.

Optionally and as shown in FIGS. 5 and 6, a second air-permeable element 20 may also be provided in front of the recuperation surface 4. This element 20, which will be called “front net”, may assume the form of a net having meshes with a width greater than the width of the meshes of the rear net 8.

The front net 20 preferably has meshes with a size of about 2.5 to 5 mm².

The aim of the front net 20 is to form a filter, capturing plant elements before they enter the fins 40, while the rear net 8 seeks to allow the air to pass while breaking the air flow F, and to recover the residual droplets carried by the air flow F.

The panel 2 has a substantially vertical longitudinal direction Z, and a transverse direction substantially parallel to the ground and aligned with a direction of advance X of the machine 10.

In the illustrated example, the fins 40 extend along the longitudinal direction Z of the panel 2. In this case, the width of the fins 40 is defined as being their dimension along a direction perpendicular to the longitudinal direction Z. Alternatively, the fins 40 may be oriented differently relative to the longitudinal direction Z.

According to an embodiment shown in FIG. 9, the width of the fins 40 may be variable between the front side and the rear side of the panels 2A and 2B. The fins arranged on the front of the panel 2A or 2B are not as wide as the fins arranged on the rear part of the panel 2A or 2B. In an alternative shown in FIG. 10, the fins 40 arranged on the rear may have an equivalent width, but a position on the panel that offsets the fins toward the opposite panel (or toward the corresponding device 12).

According to an embodiment shown in FIG. 11, the recuperation panel 2 may comprise two planes of fins on either side of a central plane Pc, forming two recuperation surfaces 4 making it possible to recover product on two opposite faces. The two planes of fins may be separated by nets, or by a partition, or by a combination of nets and partitions.

The orientation θ of the fins 40 may be controlled by slaving as a function of the orientation of the nozzles of the devices 12 and/or the speed of advance of the machine 10. The slaving may also depend on the speed of the surrounding wind. This slaving may be done using orientation sensors of the fins 40 and an electronic control unit. The speed of advance of the machine may be between 5 and 10 km/h.

Overall, the panel 2 forms an air-permeable assembly, i.e., the air may pass through it from one face to the other, and there is no rebound phenomenon on flat surfaces opposite the direction of the air.

The blown air flow F may have a width of about 30 cm when it arrives on the panel 2.

The features of the embodiments and alternatives described above may be combined to form new embodiments of the invention.

1. A phytosanitary product recuperation panel, comprising a recuperation surface extending along a main plane, and a recuperation tray located on one edge of the recuperation surface so as to receive the phytosanitary product by flow over the recuperation surface, wherein the recuperation surface is formed by a plurality of fins spaced apart such that a flow of air can traverse the recuperation surface by passing between the fins.

2. The recuperation panel according to claim 1, wherein the fins are tilted relative to the main plane so as to form a continuous obstacle along a direction perpendicular to the main plane.

3. The recuperation panel according to claim 1, wherein it comprises an element that is permeable to the passage of air, the area of which is substantially equal to that of the recuperation surface, extending along the main plane and located behind the recuperation surface such that a flow of air traversing the panel passes first through the fins then through the element permeable to the passage of air.

4. The recuperation panel according to claim 3, wherein the element permeable to the passage of air has meshes, the size of which is comprised between 0.5 and 2.5 mm², preferably equal to 1 mm².

5. The recuperation panel according to claim 3, wherein the element that is permeable to the passage of air is a net.

6. The recuperation panel according to claim 3, wherein the element that is permeable to the passage of air is placed at a distance from the fins between 0 and 150 mm.

7. The recuperation panel according to claim 3, wherein it comprises a filtering element that is permeable to the passage of air, extending in front of the recuperation surface, said filtering element having meshes with a size greater than the size of the meshes of the element that is permeable to the passage of air located behind the recuperation surface.

8. The recuperation panel according to claim 1, wherein the fins have a variable orientation relative to the main plane.

9. The recuperation panel according to claim 1, wherein it comprises two recuperation surfaces, formed by a plurality of fins spaced apart such that a flow of air can traverse said two recuperation surfaces by passing between the fins, located on two opposite faces of the panel on either side of a central plane.

10. A machine for spraying phytosanitary product in a viticultural crop, comprising at least one spraying device comprising at least one nozzle for spraying phytosanitary product capable of spraying the phytosanitary product on a first side of a vine, and at least one recuperation panel according to claim 1 located on an opposite side of said vine across from the spray nozzle.

11. The spraying machine according to claim 10, wherein the spraying device is provided on a first recuperation panel and capable of spraying phytosanitary product toward a second recuperation panel located across from the vine, the machine also comprising a second spraying device provided on the second recuperation panel and capable of spraying phytosanitary product toward the first recuperation panel.

12. The spraying machine according to claim 11, wherein the spraying device provided on the first recuperation panel is located in front of said panel, relative to the direction of advance of the machine, and the spraying device provided on the second recuperation panel is located behind said panel, relative to the direction of advance of the machine.

13. The spraying machine according to claim 10, wherein the fins of the recuperation panels have a variable orientation relative to the main plane, and wherein the machine is capable of controlling said orientation in a slaved manner as a function of at least one orientation of the spray nozzles and/or a speed of advance of the machine.

14. The spraying machine according to claim 10, wherein the panels have a substantially vertical longitudinal direction, and a transverse direction substantially parallel to the ground and aligned with a direction of advance of the spraying machine.

15. The spraying machine according to claim 14, wherein the fins extend along the longitudinal direction of the panels.
